(19) United States
(12) Patent Application Publication
(10) Pub. No.: US 2007/0139444 A1
(43) Pub. Date: Jun. 21, 2007

(54) Methods and apparatus predicting variations in material properties

(76) Inventors: Keith Andrew Dupont, Rochester, MI (US); Narendra Anand Hardikar, Bangalore (IN); Michael Edward Price, Pinckney, MI (US); Sriharsha Chunduru, Koramangala (IN); Triloka Chander Tankala, Bangalore (IN)

Correspondence Address: GEAM - 08CT;IP LEGAL, ONE PLASTICS AVENUE, PITTSFIELD, MA, 01201-3697, US

(21) Appl. No.: 11/303,373

(22) Filed: Dec. 16, 2005

(51) Int. Cl. G09G 5/00

(52) U.S. Cl. 345/647

(57) ABSTRACT

A method for using an electronic computer to model a deformable object includes generating a point cloud of (x,y) coordinates, developing computer aided design (CAD) surfaces at a region of interest (ROI) using the point cloud as an input; and calculating a displacement field using a finite element method and the CAD surfaces.

### BACKGROUND OF THE INVENTION

This invention relates generally to computer-implemented methods and apparatus for computing variation in material properties, and more particularly to solving for such variations using techniques in both the structural and the flow domain.

A primary function of a throttle body is to maintain a prescribed mass flow rate variation at “engine idle” conditions. Mass flow in the throttle body is very sensitive to the magnitude and shape of a minimum clearance area in the flow-path and pressure differential. The clearance area is strongly affected by manufacturing tolerances and structural and thermal deformations under operating loads. These deformations are dependent upon the material from which the throttle body is manufactured. Aluminum is the material of choice for the design of known electronic throttle bodies because it meets performance criteria for these devices quite well. However, although deformations are also dependent upon processing conditions in the case of thermoplastics, the use of engineering thermoplastic for electronic throttle bodies can lead to a system cost savings of 15-20%. These cost savings can be attributed to the absence of secondary operations on the thermoplastic throttle body.

Experimental validation of the feasibility of thermoplastic materials in this application requires the manufacture of a large number of prototypes. However, tooling for a thermoplastic throttle body is costly and time-consuming. Also, validation results obtained for a prototype with any particular molding gate scheme will not be more generally applicable to other gating schemes or for other grades of thermoplastics.

Experimentation and spreadsheets based on empirical knowledge have been used for designing aluminum throttle bodies. CFD (Computational Fluid Dynamics) methods have been used for mass flow predictions in throttle bodies on a straight bore. Finite element methods have also been used for predicting structural deformations for throttle bodies. For example, individual commercial software programs such as MOLDFLOW® software is available for processing, ABAQUS® software for deformation, and FLUENT® software for flow prediction are available. However, no sequential interlinking is provided for thermoplastic throttle body. Though MOLDFLOW® software can perform simulations with 3-D tetrahedron elements, the MOLDFLOW® software - ABAQUS® software interface is available only for triangular shell elements and not for 3-D elements. At least one element translator is available. However, the three node triangle is a very stiff FE element and some practical situations cannot be modeled using triangular elements. The modeling difficulty is especially apparent when section thickness is greater than recommended limits within which shell elements can be used.

In 3-D simulations, MOLDFLOW® software predicts nine orthotopic constants and principal directions with reference to a global system for each element in a mesh at a single Gauss point. However, the ability to solve a FE problem in which every element has different material property and different material orientation is available with ABAQUS® version 6.1 software, released January 2005, which can solve this problem for a 3-D tetrahedron.

Interlinking ABAQUS® software and FLUENT® software has been difficult. However, the linking of deformation software and flow prediction software is essential for the prediction of thermoplastic throttle body performance, for the performance evaluation of thermoplastic materials, and for a performance comparison with aluminum. Deformation information is also an essential for devising a flow control strategy for thermoplastic ETB. Although a link has been made available via a third party mesh-based parallel code coupling interface (MPCCI), the interface principle of communication between FEM and CFD codes used by MPCCI does not allow capturing the effect of manufacturing tolerances on fluid flow.

More generally, it is believed that no interlinking of finite element codes and computational fluid mechanic codes for throttle body applications has previously been attempted.

### BRIEF DESCRIPTION OF THE INVENTION

Therefore, in one aspect, some configurations of the present invention provide a method for using an electronic computer to model a deformable object. The method includes generating a point cloud of (x,y) coordinates, developing computer aided design (CAD) surfaces at a region of interest (ROI) using the point cloud as an input; and calculating a displacement field using a finite element method and the CAD surfaces.

In another aspect, some configurations of the present invention provide a medium or media having recorded thereon machine-readable instructions configured to instruct a computer to model a deformable object. The instructions are configured to generate a point cloud of (x,y) coordinates, develop computer aided design (CAD) surfaces at a region of interest (ROI) using the point cloud as an input, and calculate a displacement field using a finite element method and the CAD surfaces.

In yet another aspect, some configurations of the present invention provide a computer system having at least one processor, a display, and memory that includes either primary memory or secondary memory, or both. The memory includes instructions configured to generate a point cloud of (x,y) coordinates, develop computer aided design (CAD) surfaces at a region of interest (ROI) using the point cloud as an input, and calculate a displacement field using a finite element method and the CAD surfaces.

It will be appreciated that of the present invention can be used to generate numerical predictions for computing variation in material property, and/or the effect of this variation on clearance and consequently on mass flow variation with design parameters. Configurations of the present invention can thus be used to economically and optimally design and develop thermoplastic throttle bodies, among other things.

### BRIEF DESCRIPTION OF THE DRAWINGS

FIG. 1 is a drawing showing locations used in some configurations of the present invention for capturing displacement of a bore and a valve.

FIGS. 2 and 3 are drawings showing grid mismatch between finite element (FE) analysis and computational fluid dynamics (CFD) analysis.

FIG. 4 is a flowchart showing sequential interlinking used in some configurations of the present invention.

FIG. 5 is a drawing showing an exemplary bore centerline curvature transition.

FIG. 6 is a table of points used in some configurations of the present invention to define a bore locus. The table contains an equation used to compute intersection points between a line that represents the valve in a cut plane and the bore. These points are used to define a complete bore section.

FIGS. 7 and 8 show bore geometry parameters in the X-Z plane.

FIG. 9 shows varation of Y-coordinate functions in an inclined bore section.

FIG. 10 is a drawing depicting bore intercept geometry calculations on an outlet side.

FIG. 11 is a drawing depicting bore intercept geometry calculations on an inlet side.

FIG. 12 is a drawing of a geometric bore section.

FIGS. 13 and 14 are geometrical representations showing valve profile generation by turning.

FIGS. 15 and 16 are drawings showing a valve geometry relationship.

FIG. 17 is a drawing representing the effect of valve rotation on the valve face geometric center.

FIG. 18 is a drawing representing a radial clearance calculation method configuration.

FIG. 19 is a graph showing radial variation of nodal co-ordinates obtained from an FE model.

FIG. 20 is a drawing of a flow chart showing steps in a configuration of an FE interpolation procedure.

FIG. 21 is a drawing of a flowchart showing an element search procedure configuration.

FIG. 22 is a drawing of a flowchart showing a unique element identification procedure configuration.

FIG. 23 is a drawing showing six nodes of a triangle used to compute an equation of a plane.

FIG. 24 is a drawing showing the splitting of a triangle defined by the corner nodes of an elemental face.

### DETAILED DESCRIPTION OF THE INVENTION

Some configurations of the present invention include a method and/or an apparatus numerically determines variation in material property, the effect of such variation on clearance and the consequential effect on mass flow variation as a function of various design parameters. As a result, the design and development of engineering thermoplastic throttle bodies can proceed economically. Numerical predictive capability is provided for two distinct problems in two domains, namely the structural domain and flow domain. Method configurations of the present invention can be performed using a computer system having a processor, primary and/or secondary memory configured for program and data storage, and a display, wherein the memory contains a stored program with instructions configured to operate the processor to perform the prescribed functions. Some apparatus configurations comprise a machine-readable electronic, optical, or magnetic medium, such as a floppy disk, a hard disk, magnetic tape, an optical medium (e.g., CD-ROM, DVD-ROM, CD-RW, CD-R, etc.), or memory such as flash memory (e.g., a memory stick or card) on which is written the instructions configured to perform a processor to perform the prescribed functions. Technical effects of the present invention include the generation of numerical predictions used to compute variation in material property, and/or its effect on clearance and consequently on mass flow variation with design parameters. Configurations of the present invention can thus be used to economically and optimally design and develop thermoplastic throttle bodies, among other things.

Some configurations of the present invention use different mesh types and densities to discretize media for the two domains. Also, in some configurations of the present invention, the equation of elasticity is solved and the displacement field for given structural loads and boundary conditions are predicted. Continuity, momentum and energy equations are solved in the flow domain in which boundaries have changed as are result of the structural displacement field. This structural problem is solved using ABAQUS® software and the flow problem is solved using FLUENT® software, both of which are commercially available.

In some configurations of the present invention, FEM (Finite Element Method) code and CFD (Computational Fluid Dynamics) code are interlinked. More particularly, in some configurations of the present invention, commercially available code for finite element analysis is linked with computational fluid dynamics code using analytical geometry, a finite element interpolation method and CAD (Computed Aided Drawing) methods.

Analytical relations are used to generate precise theoretical geometry in the form of a point cloud having X and Y co-ordinates. CAD surfaces at a location of interest (e.g., a minimum clearance area) are developed that accept the analytically computed point cloud as input. Generally, point-based CAD surfaces require a large number of points to precisely capture bore geometry. A point-based surface is used to update the geometry with deformation information generated by finite element code. However, a practical FE mesh cannot have nodes, which are equal to the number of points required for accurate CAD surface generation. Hence, in some configurations of the present invention, the geometry field is predicted using analytical relations and FEM is used only for a displacement field calculation. A search employing (for example) an ANSYS APDL (Ansys Parametric Development language), determines element faces and nodes in the FE finite element mesh that correspond to each geometry point in the point cloud. These element faces and nodes in the FE mesh will be used for interpolating displacements at geometry points. An interpolation routine using appropriate element shape functions is used to interpolate displacement obtained at nodes after a FINITE ELEMENT simulation. The structural deformation is captured by the addition of displacement to the point cloud. The deformed CAD surfaces are then used to regenerate a CFD grid and flow computations are performed using the new CFD grid.

The following nomenclature is used herein:
y=Y coordinate of a circle with a radius R_{b} at xᵢₗ<x<xᵢᵣ where depending on plane i=f, m, b
y_{cl}=Y coordinate of a circle with a radius R_{b} at x−x_{corr}⁰ and x satisfying xᵢₙₜₗⁱ<x<xᵢₗ
y_{cr}=Y coordinate of a circle with a radius R_{b} at x+x_{corr}¹ and x satisfying xᵢᵣ<x<xᵢₙₜᵣⁱ
Rᵥₚ=Radius of a valve in a projected plane after it is turned on a lathe machine.
θₜᵢₗₜ=Angle of tilt of a blanked valve disc on the lathe fixture.
C_{θ}_{_{xy}}=Radial clearance calculated at an angle subtended at bore center by a point on a bore defined by (x_{b}, y_{b})
A=Coefficient of the “X” term in a equation of a plane
B=Coefficient of the “Y” term in a equation of a plane
C=Coefficient of the “Z” term in a equation of a plane
D=Plane constant
ηₓ=Direction cosine of plane in X direction
η_{y}=Direction cosine of plane in Y direction
η_{z}=Direction cosine of plane in Z direction
X_{G}, Y_{G}, Z_{G}=Cartesian coordinates of a geometry point on which displacement are interpolated
Xₚ, Yₚ, Zₚ=Cartesian coordinates of a geometry point when projected on a plane defined by the three corner nodes of a triangular element
N1-N6=Shape functions for a six—noded triangular element determined using the position of a projected point in a triangle defined by a element corner node.
U_{iX}, U_{iY}, U_{iZ}=Global Cartesian displacement obtained at the ith node (i=1,6) of a six—noded element
U_{PX}, U_{PY}, U_{PZ}=Global Cartesian displacement interpolated at a projected point using displacements obtained at 6 nodes and computed shape functions
U_{LX}, U_{LY}, U_{LZ}=Local Cartesian displacement obtained by transforming the interpolated displacement into a system defined by valve rotation angle.
[T]=Transformation matrix generated using the value of the valve rotation angle.

The following abbreviations and trademarked names are used herein:

| | |
|---|---|
| FEM | Finite Element Analysis |
| CFD | Computational Fluid Dynamics |
| ETB | Electronic Throttle body |
| MOLDFLOW ® | Processing Simulation Code developed by Moldflow |
| | Corporation |
| ABAQUS ® | Non-linear Finite Element code developed |
| | by Hibbit, Karlsson &Sorensen. Inc |
| ANSYS ® | Non-linear Finite Element code developed |
| | by SAS IP. Inc |
| APDL | Ansys Parametric Devlopment Language |
| UNIGRAPHICS ® | CAD software developed by Unigraphics |
| | Solutions Inc |
| FLUENT ® | CFD code developed by Fluent Inc |

Material properties and processing parameters affect deformations, and thus, mass flow. Therefore, some configurations of the present invention provide a predictive technique for thermoplastic material for determining material flows, bore-valve deformations under thermal and structural loads, and the mass flow variance resulting from thermo-mechanical deformations.

The mass flow through a throttle body is very sensitive to minimum flow area and pressure differential. It can be shown that that radial pressure gradients due air flow in the bore of a throttle body are not high enough to perceptibly change the stiffness or deformation of the throttle body. However, very small radial displacement significantly affects mass flow values. Thus, the effect of fluid pressure on throttle body structures is considered negligible, thereby allowing a sequential rather than a fully coupled solution for the mass flow problem.

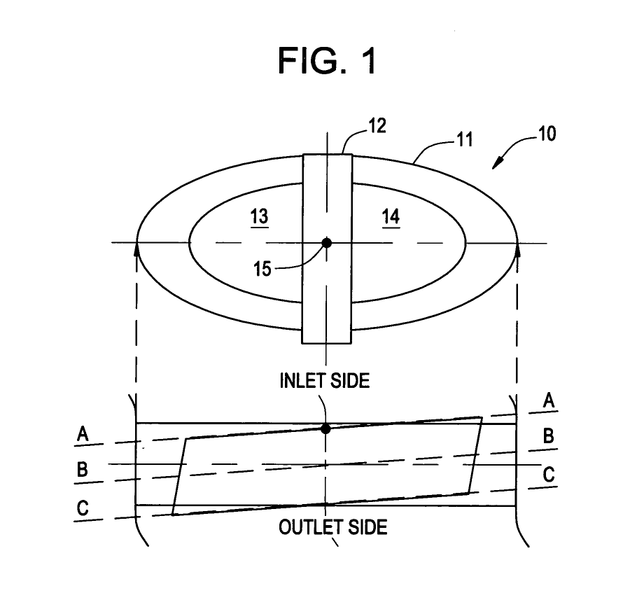

Mass flow passing through a throttle body at any given pressure differential is governed by the magnitude and shape of the minimum flow area encountered in the flow path. Because of the curved nature of the progressive bore, the location of the minimum cross section area is strongly dependent on the bore curvature. However, referring to FIG. 1, the minima will always occur in a region bounded by a set of planes that include planes parallel to front and back faces of the valve and planes that pass through the faces, namely planes A-A and C-C. (Also shown in FIG. 1 is an area 11 enclosed by a bore profile, a shaft area 12 blocking a flow, valve arms 13 and 14 blocking a flow, and a clearance area comprising area 11 minus the sum of the areas 12, 13, and 14. Plane A is defined by the front face of valve 10. Plane B is defined by the midsection of valve 10. Plane C is defined by the back face of valve 10. Also shown is bore center 15 in A-A.) Variation of geometry in other regions has little or no effect on mass flow predictions. Thus, some configurations of the present invention utilize the simplification that, from a flow perspective, the effect of displacement need be determined only in the region with these boundary planes. Structural displacement in other region need not be determined.

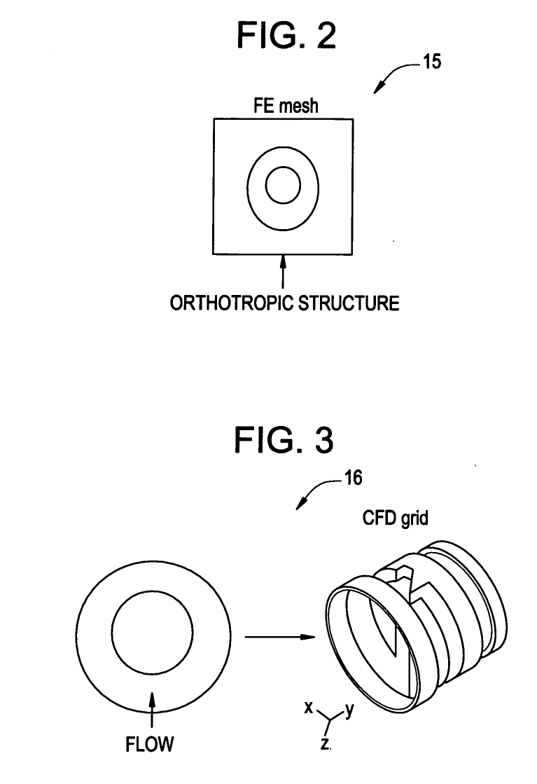

Referring to FIGS. 2 and 3, the FE domain 16 and CFD domain 17 are complimentary in nature and no one-to-one correspondence exists between the two meshes. The bore inner and valve outer surfaces form a common region between the structure domain and the flow domain. Deformations of these surfaces would change the geometry in a region of interest (ROI). Thus, some configurations of the present invention capture differential changes in the ROI and store these changes as surface data from which a CFD mesh 17 can be generated. Some configurations also accurately update surfaces when deformed. In some configurations of the present invention, the updates are extremely accurate, as clearances in the ROI can measure only a fraction of a millimeter.

Computer aided design (CAD) allows surfaces to be generated using a point cloud (i.e., a collection of points). Thus, some configurations of the present invention provide interlinking by updating a collection of points to generate deformed surfaces.

Point clouds are generated by analytical relationships that are derived for progressive bores. Analytical relationships are used because a tolerance study is possible only with such relationships, and in addition, 3-D CAD models are not available during preliminary design stages for which the virtual flow predictor method is being developed.

Tolerance studies are used in flow predictions at low valve angles, and analytical relationships can be advantageously used in tolerance studies. Flow considerations are used to determine the clearance in ETB, but configurations of the present invention also determine clearance values that would survive thermal loads without causing bore-valve interference. Analytical relations useful for clearance variation in some configurations of the present invention are provided elsewhere herein. In cases in which the geometry is very complicated, a point cloud generated from a representative CAD can also be utilized to achieve the interlinking.

FE models are used in some configurations of the present invention to capture (i.e., determine) deformations. However the ROI in which displacement is to be determined varies with the valve rotation angle at which flow pattern is to be studied. In previously known methods for determining displacement, different FE models are used for each valve angle. By contrast, in configurations of the present invention, one or more interpolations are performed instead.

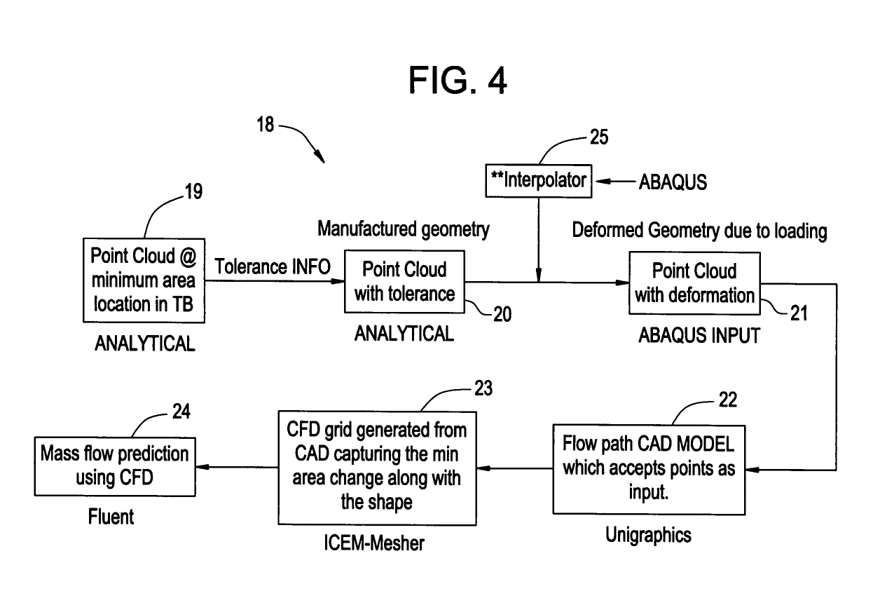

In some configurations and referring to flowchart 18 of FIG. 4, a sequential interlinking procedure is used. Although ABAQUS® software and FLUENT® software is specifically mentioned in connection with these configurations of the present invention, similar procedures can be used to perform interlinking analysis for throttle bodies by capturing deformation using other standard or custom FE code and by performing fluid flow analysis using other standard or custom CFD code. Referring to FIG. 4, a point cloud at a minimum area location in the throttle body (TB) is generated at 19. From the point cloud generated at 19 and given tolerance information, a second point cloud is generated as a manufactured geometry at 20. Using the point cloud at 20 and an interpolator 25, a point cloud with deformation(s) due to loading is generated at 21. The point cloud with deformation(s) is used as input to a flow path CAD model that accepts points as input at 22. Next, a CFD grid is generated from CAD capturing the minimum area change along with shape at 23, followed by a mass flow prediction being made at 24 from the information generated at 23.

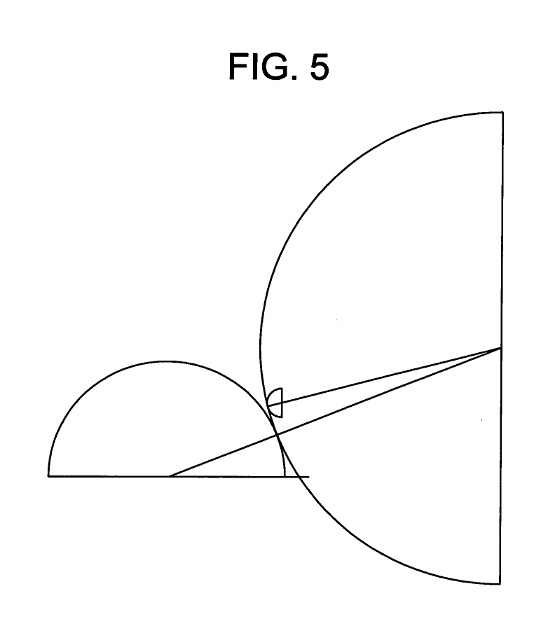

The profile of a progressive bore under study is generated by extruding a circle about a curved centerline with the constraint that any horizontal section of the extruded geometry remains a circle. The centerline includes one straight segment on the inlet of the bore and several circular segments on the outlet of the bore. The current applicant has observed that the transition of circular segments from one radius of curvature to another occurs at a common point of tangency of the two circular segments. The point of common tangency is determined by joining the centers of curvature of the two segments by a straight line and then, depending upon the internal or external division of the line, dividing the line between the centers by an appropriate radius ratio. Internal division occurs when the radii difference equals the distance between the centers. An external division occurs when the sum of the radii equals the distance between the centers. FIG. 5 depicts the bore centerline curvature transition on the inlet side for one particular bore profile.

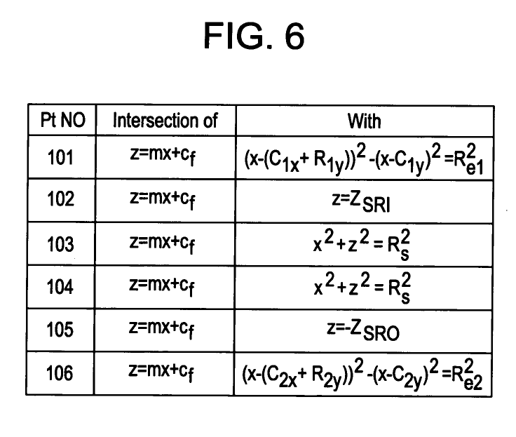

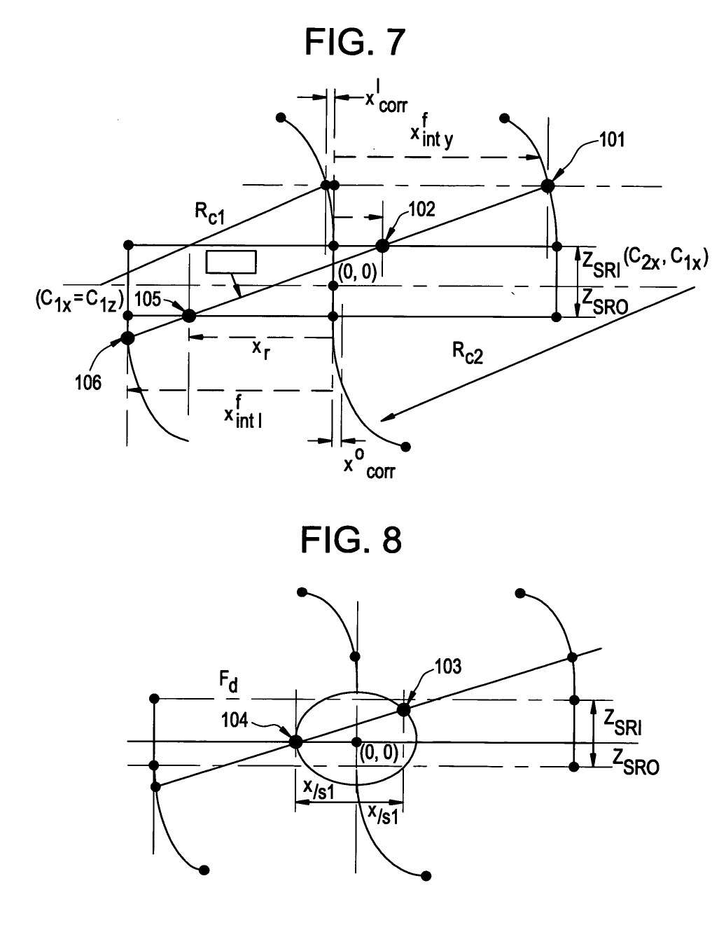

In some configurations of the present invention, the bore locus is generated in an X-Y plane from a flow perspective in a plane defined by a valve rotation angle. As a result of the nature of the bore centerline, some parts of a section of a generic bore would lie in a straight portion of the bore and some parts of the section outside it. In such sections, it can be shown that a maximum of three different Y ordinate functions exists. If the valve rotation angle is such that the section lies completely in the straight portion of the bore, then the section generated is an ellipse. For example, and referring to FIGS. 6, 7, and 8, four points 101, 102, 103, and 104 determine how the Y-ordinate varies in a selected plane are illustrated. These points are obtained using the bore geometry in an X-Z plane. These points are at the intersection of a straight line with different curves as listed in FIG. 6. The radius of curvature of a curve that is to be used in an intersection calculation is dependent upon the valve rotation angle. In some configurations of the present invention, a software program uses derived analytical equations and the transition points of the bore centerline to determine which radius of curvature to use for further calculations.

These four points 101, 102, 105, and 106 also are useful for area determinations as they represent integration limits for bore-section area calculation. For example and referring to FIG. 8, points 103 and 104 represent the intersection of the shaft with the bore. Points 103 and 104 are used in some configurations of the present invention to identify interference points of the shaft with the bore and also are used for determine the shaft-projected area

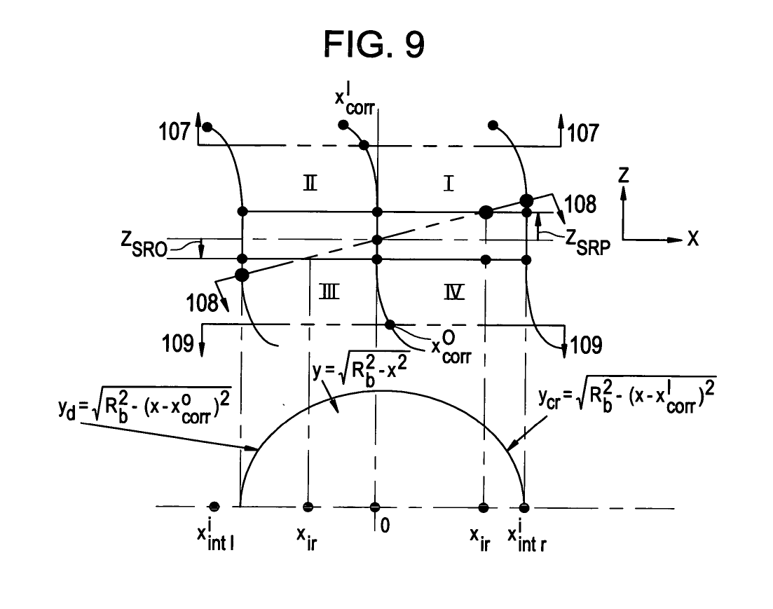

FIG. 9 represents Y ordinate function variation and dependence with X co-ordinate in some configurations of the present invention. A normal cylinder horizontal section such as section 107-107 produces a circle and an inclined section such as section 108-108 produces an ellipse. For a progressive bore representative section depicted below, sections 107-107 and 109-109 also produce circles. However, an inclined section 108-108 does not produce a complete ellipse. Sections 107-107 and 109-109, though circles in the X-Y plane, have their section centers shifted from the bore centerline by x_{corr}^{I} and x_{corr}^{O} respectively. A part of the resulting profile 108-108 (xᵢₗ to xᵢᵣ) is an ellipse. Other sections of the profile do not follow a normal ellipse definition and have a different variation of y_{cl} on the left side between the limits (xᵢₙₜₗⁱ, xₗⁱ) and y_{cr}on the right side between the limits (xᵢₙₜᵣⁱ, xᵣⁱ). The formula for Y provided here assumes that any horizontal section for the given bore profile is a circle having a center that deviates from the bore centerline of the straight portion by x_{corr}^{I} and x_{corr}^{O} on the inlet section and the outlet section of the bore, respectively. The centerline deviation x_{corr}^{I} exists for any x that satisfies xᵢᵣ<x<xᵢₙₜᵣⁱ, while x_{corr}^{O} exists for any x that satisfies xᵢₗ<x<0. The deviation values are dependent on the value of the X coordinate itself.

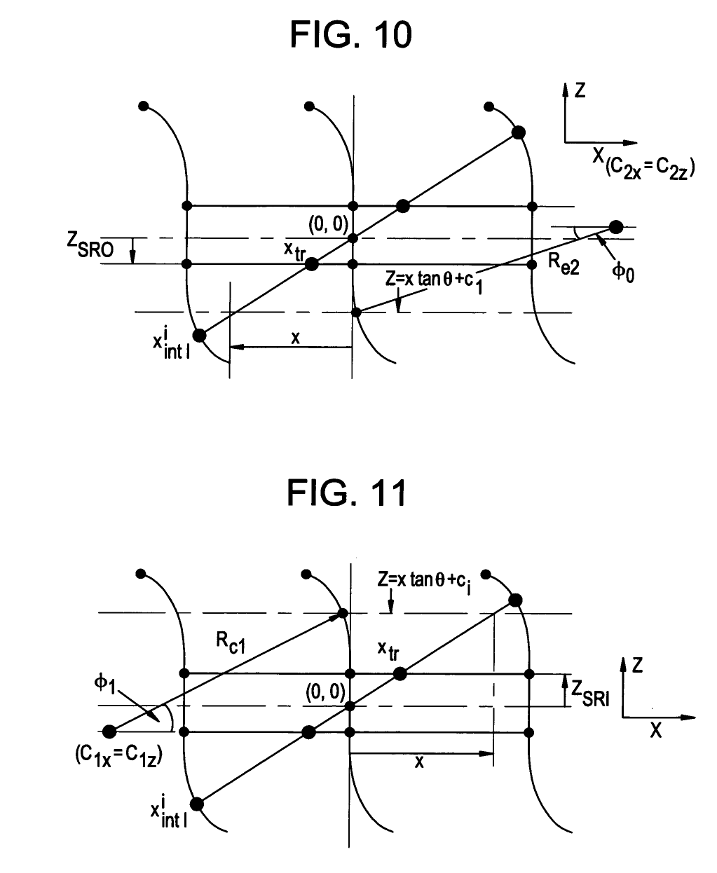

For a given valve rotation angle θ and section (which could be the front, middle, or back face) and referring also to FIG. 10, the following relationships are valid for the left side (quadrant II or II of the X-Z plane in FIG. 9):

$${Z}_{SRO} = - ( \sqrt{{R}_{c 2}^{2} - {C}_{2 x}^{2}} - {C}_{2 z} )$$

$$IF$$

$$\frac{- {Z}_{SRO} - {c}_{i}}{m} <= - {R}_{b}$$

$$\begin{matrix}{x}_{il} = {x}_{int l}^{i} \\ = - {R}_{b}\end{matrix}$$

$$ELSE$$

$${x}_{il} = \frac{- {Z}_{SRO} - {c}_{i}}{m}$$

$${x}_{int l}^{i} = \frac{- B 2 \_lin - \sqrt{B 2 {\_lin}^{2} - 4 * A\_quad * C 2 \_const}}{2 * A\_quad}$$

xᵢₙₜₗⁱ will lie in the second or third quadrant, hence, a negative sign appears in the quadratic formula above, where A_quad=1+m².

$$B 2 \_lin = 2 {mLCONST}_{Z} - 2 {LCONST}_{X}$$

$$C 2 \_const = {LCONST}_{X}^{2} + {LCONST}_{Z}^{2} - {R}_{c 2}^{2}$$

$${LCONST}_{Z} = {c}_{i -} {C}_{2 z}$$

$${LCONST}_{X} = {C}_{2 x} - {R}_{b}$$

$${x}_{isl} = \frac{- B 3 \_lin - \sqrt{B 3 {\_lin}^{2} - 4 * A\_quad * C 3 \_const}}{2 * A\_quad}$$

$$where \text{:}$$

$$B 3 \_lin = 2 m {c}_{i}$$

$$C 3 \_const = {c}_{i}^{2} - {R}_{s}^{2}$$

$${x}_{corr}^{O} = {C}_{2 x} - {R}_{c 2} cos {ϕ}_{o}$$

$$where \text{:}$$

$${ϕ}_{o} = {Sin}^{- 1} ( \frac{( x tan θ + {c}_{i} ) - {C}_{2 z}}{{R}_{c 2}} )$$

where:

$${c}_{i} i = f , m , b \&$$

$${c}_{f} = \frac{0.5 t}{Cos θ} ;$$

$${c}_{b} = - \frac{0.5 t}{Cos θ} ;$$

$${c}_{m} = 0 ;$$

$$y = \begin{matrix}\sqrt{{R}_{b}^{2} - {x}^{2}} & for {x}_{il} < x < 0\end{matrix}$$

$${y}_{cl} = \begin{matrix}\sqrt{{R}_{b}^{2} - {( x - {x}_{corr}^{O} )}^{2}} & for {x}_{int l}^{i} < x < {x}_{il}\end{matrix}$$

For a given valve rotation angle θ and section (which could be the front, middle, or back face) and referring also to FIG. 11, the following relationships are valid for the right side (quadrant I or IV of the X-Z plane in FIG. 9):

$${Z}_{SRI} = \sqrt{{R}_{c 1}^{2} - {C}_{1 x}^{2}} + {C}_{1 z}$$

$$IF$$

$$\frac{{Z}_{SRI} - {c}_{i}}{m} >= {R}_{b}$$

$$\begin{matrix}{x}_{ir} = {x}_{int r}^{i} \\ = {R}_{b}\end{matrix}$$

$$ELSE$$

$${x}_{ir} = \frac{{Z}_{SRI} - {c}_{i}}{m}$$

$${x}_{ir} = \frac{{Z}_{SRI} - {c}_{i}}{m}$$

$${x}_{int r}^{i} = \frac{- B 1 \_lin + \sqrt{B 1 {\_lin}^{2} - 4 * A\_quad * C 1 \_const}}{2 * A\_quad}$$

where xᵢₙₜᵣⁱ lies in the first or fourth quadrant, and hence, a positive sign appears in the quadratic formula above.

where:

$$A\_quad = 1 + {m}^{2}$$

$$B 1 \_lin = 2 {mRCONST}_{Z} - 2 {RCONST}_{X}$$

$$C 1 \_const = {RCONST}_{X}^{2} + {RCONST}_{Z}^{2} - {R}_{c 1}^{2}$$

$${RCONST}_{Z} = {c}_{i -} {C}_{1 z}$$

$${RCONST}_{X} = {C}_{1 x} + {R}_{b}$$

$${x}_{isr} = \frac{- B 3 \_lin + \sqrt{B 3 {\_lin}^{2} - 4 * A\_quad * C 3 \_const}}{2 * A\_quad}$$

$$\text{where:}$$

$$B 3 \_lin = 2 m {c}_{i}$$

$$C 3 \_const = {c}_{i}^{2} - {R}_{s}^{2}$$

$${x}_{corr}^{I} = - {C}_{1 x} - {R}_{c 1} cos {ϕ}_{I} exits for {x}_{ir} < x < {x}_{int r}^{i}$$

$$\text{where:}$$

$${ϕ}_{I} = {Sin}^{- 1} ( \frac{( x tan θ + {c}_{i} ) - {C}_{1 z}}{{R}_{c 1}} ) \& exits for for {x}_{ir} < x < {x}_{int r}^{i}$$

$$\text{where:}$$

$${c}_{i} i = f , m , b \&$$

$${c}_{f} = \frac{0.5 t}{Cos θ} ;$$

$${c}_{b} = - \frac{0.5 t}{Cos θ} ;$$

$$y = \sqrt{{R}_{b}^{2} - {x}^{2}} for 0 < x < {x}_{ir}$$

$${y}_{cr} = \sqrt{{R}_{b}^{2} - {( x + {x}_{corr}^{I} )}^{2}} for {x}_{ir} < x < {x}_{int r}^{i}$$

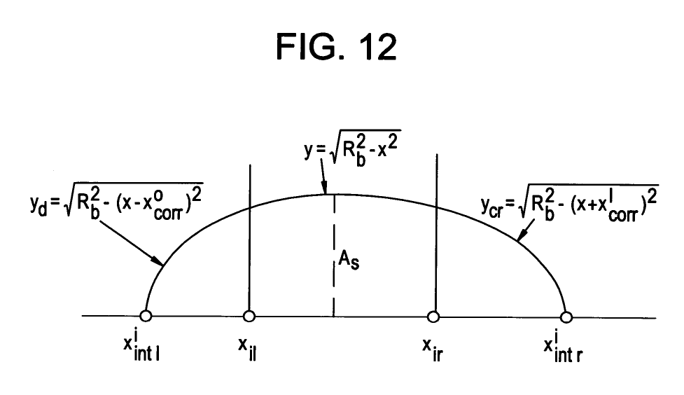

In some configurations and referring to FIG. 12, a bore section area is cut at an angle θwith respect to either the front, mid, or back valve face. A factor 2 is appears for the complete section area, because in some configurations of the present invention, symmetry of the bore about the X axis is assumed. A Secθ term compensates for integration being performed about the horizontal X rather than an inclined axis. Integration terms 1 and 3 do not have closed form solution, so that numerical integration is used in some configurations to obtain the bore cross section area. The equation below is useful for a generic cross section of a progressive bore. This equation provides the ability to predict the effect of manufacturing tolerance on the bore area. This tolerance is critical in low angle mass flow computation.

$${A}_{s} = 2 Sec θ ( {\int }_{{x}_{int l}^{i}}^{{x}_{il}} {y}_{cl} ⅆ x + {\int }_{{x}_{il}}^{{x}_{ir}} y ⅆ x + {\int }_{{x}_{ir}}^{{x}_{int r}^{i}} {y}_{cr} ⅆ x )$$

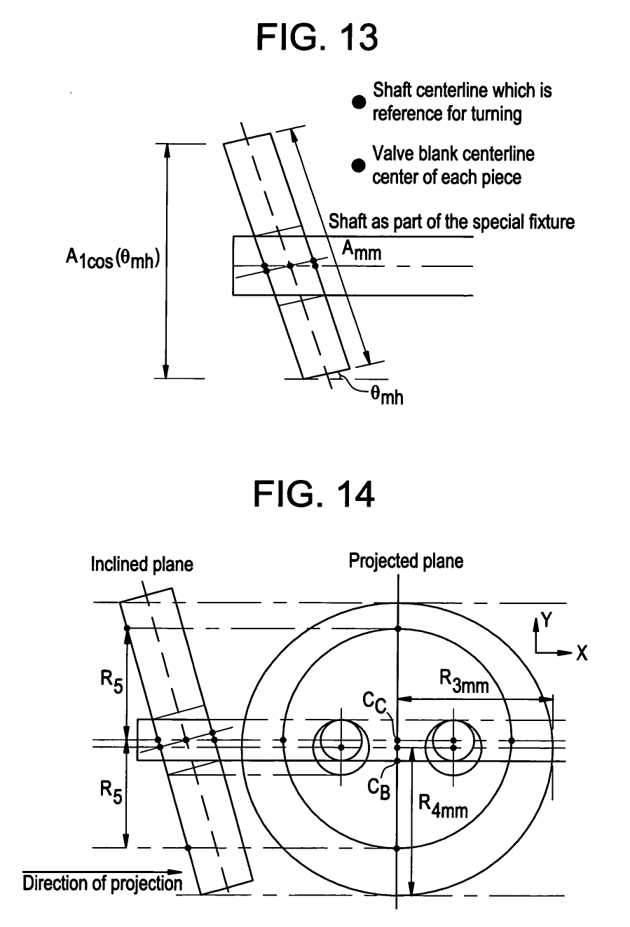

In some configurations and referring to FIGS. 13 and 14, the valve profile is derived in accordance with the manufacturing process described immediately above. In a first step, a circular disc is generated, which, for the sake of profile derivation, is blanked at R1 mm from the disc center, where R1 is a value obtained from a SOLIDWORKS® CAD model of the valve. (The blanking operation of step 2 has not been depicted in subsequent figures for sake of simplicity.). The shaft is the datum of turning, thus, the shaft center is the center of turning and eccentricity is introduced between the center of turning and center of the disc. In this example, the final vertical height of the turned valve can vary between (R2-αa) to (R2-2 α) according to the drawings provided. For the derivation of the valve profile the average vertical height of R2-1.5 α mm is assumed in this example. Thus, the process of eccentric turning makes an ellipse having a center is C_{E}, with a major radius of R3 mm and a minor radius of R4 mm into a circular disc having a center of C_{C} and a radius of R5 mm in the projected X-Y plane. As a result, the final valve profile in the inclined or actual plane is an ellipse with major diameter of R5/cos θₜᵢₗₜ and minor diameter of R5 mm that is trimmed at R1 mm from blank center. (The transformation from projected to inclined plane does not affect the horizontal X dimension).

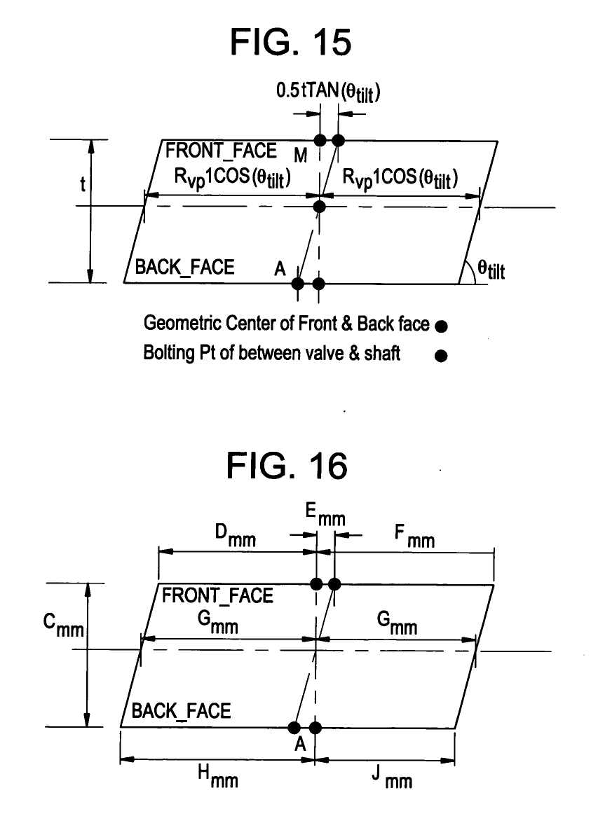

In some configurations and referring to FIGS. 15 and 16, there is a specific relationship between the geometric center of the valve face and the location where the valve is bolted to the shaft, wherein measured values from the SOLIDWORK® valve model match values predicted by the valve equations.

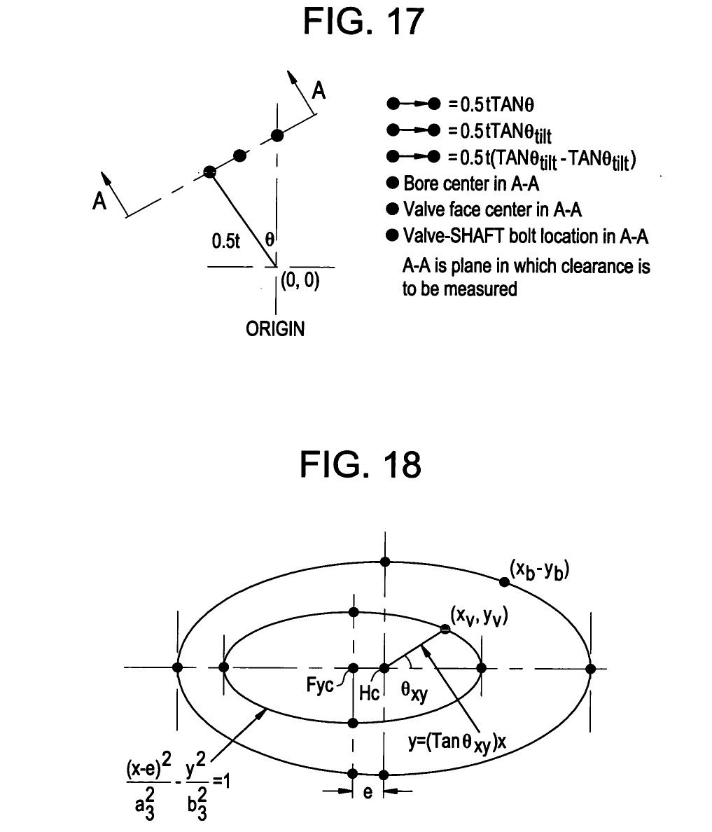

The eccentricity between the geometric center of the valve faces, the point of bolting, and the valve rotation affects radial clearance. Specifically, the valve center moves away from the bore center in the plane, as shown in FIG. 17.

In some configurations of the present invention, for a given valve angle θ and a given plane, bore limits are calculated using the bore definition equations. A part of the bore section bounded by xᵢₗ, and xᵢᵣ is an ellipse, and hence this part of the bore section can be described by a generic equation. However, other parts of the bore section do not follow an elliptic variation and cannot be defined by an equation.

To overcome the above limitation, an interval defined by xᵢₙₜᵣⁱ and xᵢₙₜₗⁱ is divided to produce a plurality of points. For each resulting point, the corresponding Y ordinate (which is a function of the horizontal X-component) is predicted. The co-ordinate in an inclined plane (Xcos θ, Y) is used to compute angle θ_{xy} subtended by the bore point at the bore center and also the local radius of bore at a given point.

Angle θ_{xy} is used to obtain a point on the valve periphery, that subtends the same angle at the bore center. The valve center has an eccentricity with the bore center such that, for the front face, the valve center Fvc lies to the left of the bore center Bc as shown in FIG. 18. For the back face, Fvc lies to the right of Bc. The local valve radius is computed using x,y co-ordinates of the valve. In some configurations, a software function or subroutine used for computing the clearance takes into account the flattening of the valve. However, FIG. 18 and the clearance equations below represent a perfect ellipse equation without flattening for the sake of simplicity of presentation.

$${C}_{{θ}_{xy}} = {R}_{b {θ}_{xy}} - {R}_{v {θ}_{xy}}$$

$$where$$

$${C}_{{θ}_{xy}} = {R}_{b {θ}_{xy}} - {R}_{v {θ}_{xy}}$$

$$and$$

$${R}_{v {θ}_{xy}} = \sqrt{{x}_{v {θ}_{xy}}^{2} + {y}_{v {θ}_{xy}}^{2}}$$

$${θ}_{xy} = {Tan}^{- 1} ( \frac{{y}_{b}}{{x}_{b}} )$$

where (xᵥ,yᵥ) is obtained by solving y=(Tan θ_{xy})x and

$$\frac{{( x - ⅇ )}^{2}}{{a}_{3}^{2}} + \frac{{y}^{2}}{{b}_{3}^{2}} = 1 ,$$

$$where$$

$${a}_{3} = {R}_{vp} / Cos ( {θ}_{tilt} ) ;$$

$${b}_{3} = {R}_{vp} ;$$

$$and$$

$$e = \frac{t * Tan θ}{2} - \frac{t * Tan {θ}_{tilt}}{2} ;$$

$$where$$

$${x}_{v} = \frac{- VB\_lin + \sqrt{{VB\_lin}^{2} - 4 * VA\_quad * V\_CONST}}{2 VA\_quad} \begin{matrix}for \\ {θ}_{xy} \leq 90\end{matrix}$$

$${x}_{v} = \frac{- VB\_lin - \sqrt{{VB\_lin}^{2} - 4 * VA\_quad * V\_CONST} for}{2 VA\_quad} \begin{matrix}{θ}_{xy} \geq \\ 90\end{matrix}$$

$$where$$

$$VA\_quad = ( {b}_{3}^{2} + {a}_{3}^{2} Tan {θ}^{2} )$$

$$VA\_quad = ( {b}_{3}^{2} + {a}_{3}^{2} Tan {θ}^{2} )$$

$$V\_CONST = {b}_{3}^{2} ( {ⅇ}^{2} - {a}_{3}^{2} )$$

The mathematical relationships above are used in some configurations of the present invention to define a locus of points for both the bore and the valve. This locus is referred to herein as a “point cloud.” Some configurations of the present invention next capture the effect of structural and/or thermo-mechanical distortions of the bore valve that can occur as a result of operational loads on the throttle body. These captured effects are then used to update the CAD models. Generally, a finite element method is used for prediction of thermo-mechanical deformation for given loads and constraints.

Some configurations of the present invention develop an accurate geometry, deform this geometry with structural displacements and then create a CAD surface representing the deformed geometry. Some configurations generate these surfaces using CAD tools that accept a point cloud as an input.

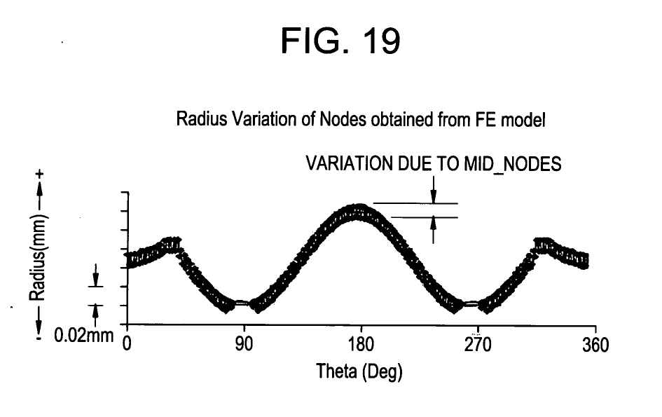

A large number of points are required to achieve acceptable accuracy for representing areas. In one study, at least 256 points were required to optimally represent an ETB bore section to obtain accurate sectional area values. In general, 256 nodes in the hoop direction of the bore leads to a large number of nodes in the model that can become prohibitive when performing a non-linear analysis.. A mesh density beyond a converged limit is computationally expensive but does not enhance displacement predictions. Additionally, radial variations obtained from FE nodes (see FIG. 19, which represents bore data) is of the same order as that of the minimum theoretical clearance (0.05 mm), thus introducing errors in clearance calculations if nodal co-ordinates are used.

An FE model could be developed for each valve angle. Mass flow through the throttle body for a given pressure differential is affected by the radial expansion-contraction of the bore and valve, so an FE analysis could be used to capture radial displacement. FE models predict displacements only at the nodes of the FE mesh, so the presence of nodes at the planes defined by the valve rotation angle is required. In cases in which clearance is to be predicted at different valve angles, different FE models would be required with nodes in desired planes and the solution procedure would have to be repeated for all FE models even when loads and boundary condition have not been altered.

Some configurations of the present invention improve upon this computationally expensive procedure by using a large number of points so that an area can be generated accurately and by using a single converged FE model for a throttle body. The single converged FE model is used to study deformations at different valve angles without having to repeat the analysis.

FEM is used in some configurations to interpolate displacements created in a geometry using analytical relationships. The use of analytical equations allows any number of points to be generated in the plane of interest, thereby satisfying CAD model requirements. Using element shape functions, global displacements obtained from a FEM solver are interpolated on geometry points to obtain radial displacement in any plane of interest, thereby eliminating the requirement for a different FE models to handle each different valve angle.

The interpolation technique used in some configurations of the present invention uses an identification of an appropriate element for every geometry point in the FE grid and shape functions computation. C and/or APDL code are used in some configurations for this identification.

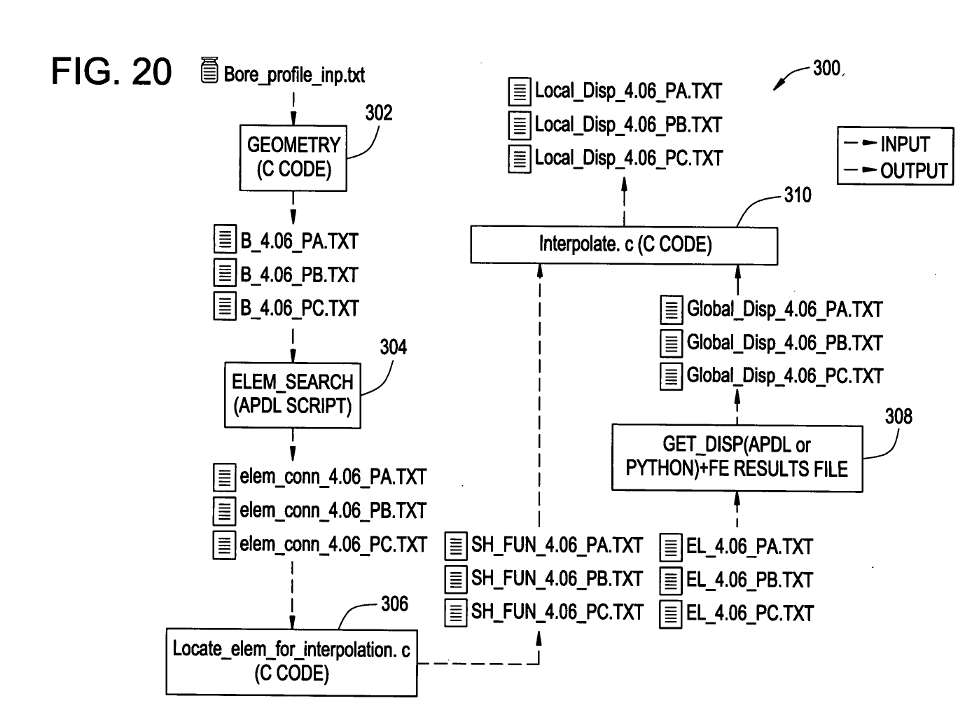

For example, in some configurations of the present invention and referring to flow chart 300 of FIG. 20, a C language program 302 uses the analytical equation for the bore profile and valve to generate a text file that contains a point cloud for each of the three planes for a given valve rotation angle for the bore and also for the valve.

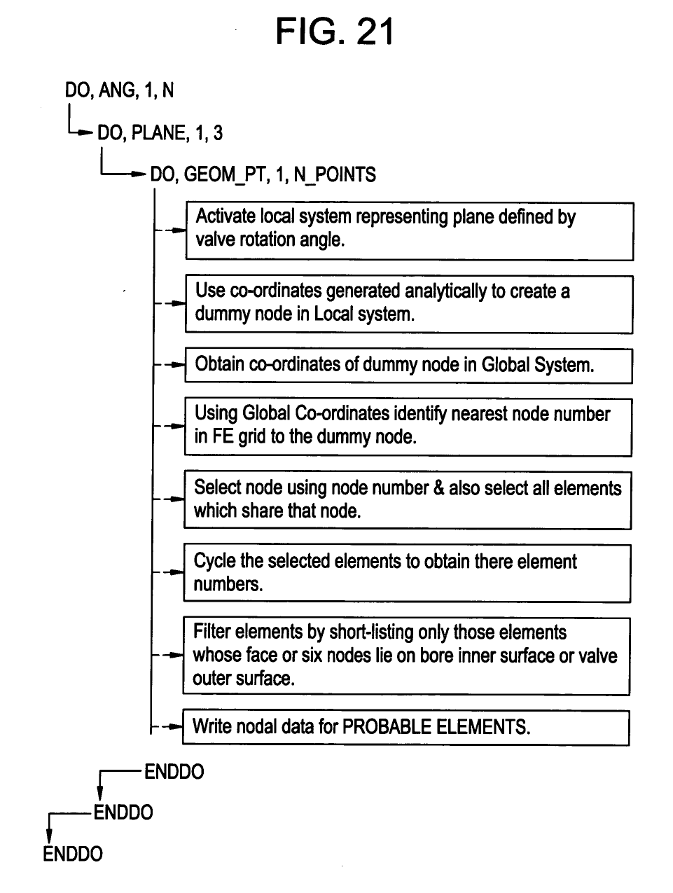

An APDL script 304 for every point in the point cloud identifies 304 a group of elements from the FE mesh in whose face the point could possibly lie. An example flow diagram suitable for some configurations of this script is shown in FIG. 21.

A “C” language program 306 then evaluates the group of element and pinpoints the exact element and face. Once the exact element is located based on the position of the point in the element face shape functions are calculated. This C code is based on the properties of a point, which, if inside a triangle defined by the nodes of the element face, would split it into max three triangles whose sum of area is equal to the original area. The output of this program is a text file, which contains the element number & six nodes in the face of that element in which the geometry point lies.

An ABAQUS® language restart file for performing the FE analysis contains displacements for the throttle body for given loads and boundary conditions. Using ABAQUS® language commands, global Cartesian displacements at node numbers obtained in 306 are obtained at 308.

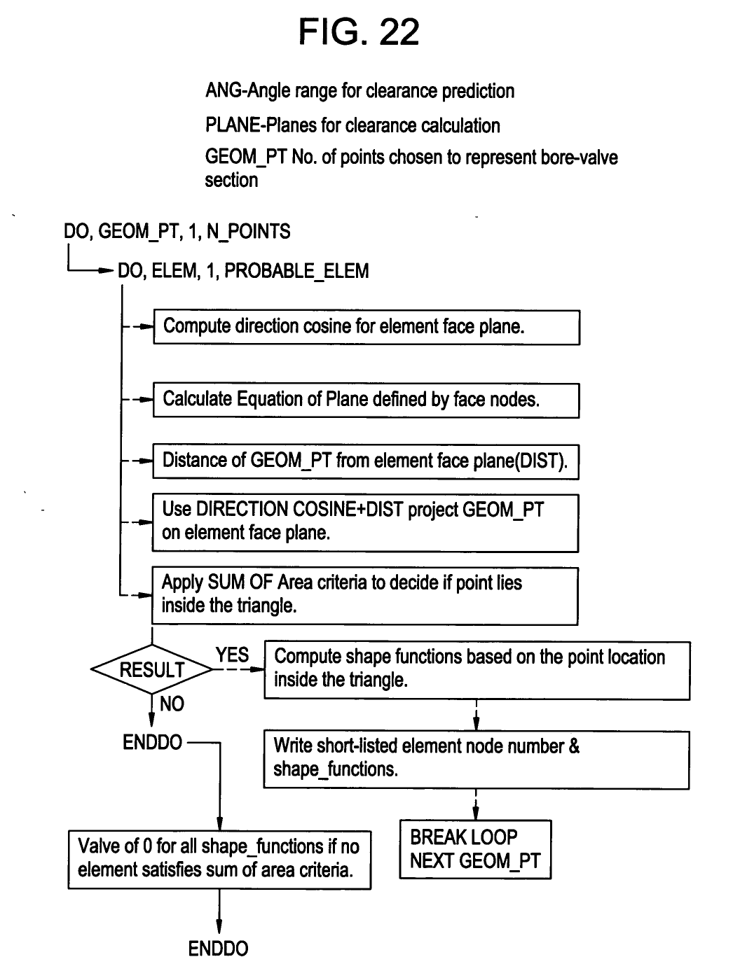

A “C” language program utilizing shape functions obtained in 306 and global displacements obtained in 308 interpolates displacements obtained at nodes to the geometry point at 310. A flow chart for one suitable configuration of this program is shown in FIG. 22. This displacement at the geometry point is measured in the global Cartesian system. Using the valve rotation angle, a transformation matrix is generated that transforms the global Cartesian displacement into the local Cartesian displacement.

The new position of a point in the point cloud is obtained by adding the local displacement obtained at a point to the original coordinates of the point.

The deformed point cloud is obtained by repeating the procedure described above for the bore and the valve at every point. The CAD model is updated with this point cloud to obtain the deformed geometry. The deformed CAD is input to the CFD grid generator.

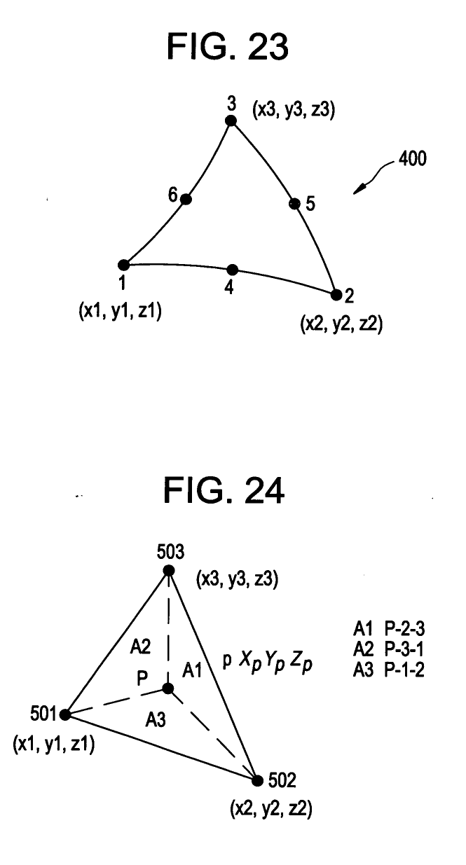

For a given geometry point (X_{G} Y_{G} Z_{G}, ),the element out of the probable elements that should be used to compute shape functions is identified. More particularly, a triangle is identified in which the point would lie. First, an equation for a plane is determined. The face of a ten-node tetrahedron is a six-node triangle 400 shown in FIG. 23. Thus, in some configurations of the present invention, the first step in the process for identifying the element that is to -be used to determine shape functions includes determining an equation for the plane defined by the three corner nodes of the triangle.

$$Ax + By + Cz + D = 0$$

$$where \text{:}$$

$$A = Det [ \begin{matrix}1 & {y}_{1} & {z}_{1} \\ 1 & {y}_{2} & {z}_{2} \\ 1 & {y}_{3} & {z}_{3}\end{matrix} ] \\ - D = Det [ \begin{matrix}{x}_{1} & {y}_{1} & {z}_{1} \\ {x}_{2} & {y}_{2} & {z}_{2} \\ {x}_{3} & {y}_{3} & {z}_{3}\end{matrix} ]$$

$$B = Det [ \begin{matrix}1 & {z}_{1} & {x}_{1} \\ 1 & {z}_{2} & {x}_{2} \\ 1 & {z}_{3} & {x}_{3}\end{matrix} ]$$

$$C = Det [ \begin{matrix}1 & {x}_{1} & {y}_{1} \\ 1 & {x}_{2} & {y}_{2} \\ 1 & {x}_{3} & {y}_{3}\end{matrix} ]$$

For calculating the area of a triangle:

$${A}_{t} = 0.5 * \sqrt{{A}^{2} + {B}^{2} + {Z}^{2}}$$

$$and$$

$${η}_{x} = \frac{A}{{A}_{t}} {η}_{y} = \frac{B}{{A}_{t}} {η}_{z} = \frac{C}{{A}_{t}} . \\ DIST = \frac{{AX}_{G} + {BY}_{G} + {CZ}_{G} + D}{\sqrt{{A}^{2} + {B}^{2} + {Z}^{2}}}$$

For calculating the distance of a geometric point from the plane:

$$DIST = \frac{{AX}_{G} + {BY}_{G} + {CZ}_{G} + D}{\sqrt{{A}^{2} + {B}^{2} + {Z}^{2}}}$$

In some configurations of the present invention, shape functions are computed only after ensuring that the point lies on the plane and also inside the triangle. If the distance is non-zero then the point is projected onto the plane. Also, in some configurations of the present invention, the sum of area criteria to evaluate whether the point lies inside the triangle can be applied when the point lies on the plane.
X_{P}=X_{G}−ηₓDIST
Y_{P}=Y_{G}−η_{y}DIST
Z_{P}=Z_{G}−η_{z}DIST

Projection of Geometry Point on Plane defined by three nodes
X_{P}=X_{G}−ηₓDIST
Y_{P}Y_{G}−η_{y}DIST
Z_{P}=Z_{G}−η_{z}DIST

Sum of Areas

Referring to FIG. 24, a triangle 500 defined by the corner nodes of an elemental face can be split into a maximum of three triangles by the projected point P. A specific order is followed in forming the triangles. If sum of the three areas is equal to the area of triangle defined by 501,-502, -and 503 then point P lies inside the triangle, in which and shape function can be calculated using the magnitude of A1-A2-A3.

The shape functions for a triangle can be expressed in terms of area co-ordinates.

$${ξ}_{1} = \frac{{A}_{1}}{{A}_{t}} {ξ}_{2} = \frac{{A}_{2}}{{A}_{t}} {ξ}_{3} = \frac{{A}_{3}}{{A}_{t}}$$

$$\begin{matrix}A 1 & P - 2 - 3 \\ A 2 & P - 3 - 1 \\ A 3 & P - 1 - 2\end{matrix}$$

$$N 1 = {ξ}_{1} ( 2 {ξ}_{1} - 1 )$$

$$N 2 = {ξ}_{2} ( 2 {ξ}_{2} - 1 )$$

$$N 3 = {ξ}_{3} ( 2 {ξ}_{3} - 1 )$$

$$N 4 = 4 {ξ}_{1} {ξ}_{2}$$

$$N 5 = 4 {ξ}_{2} {ξ}_{3}$$

$$N 6 = 4 {ξ}_{3} {ξ}_{4}$$

The shape functions for a six-node triangle are as follows.
N1=ξ₁(2δ₁−1)
N2=ξ₂(2δ₂−1)
N3=ξ₃(2δ₃−1)
N4=4ξ₁ξ₂
N5=4ξ₂ξ₃
N6=4ξ₃ξ₁

Displacement Interpolation

In some configurations of the present invention, the shape functions described above and the global Cartesian displacements from six nodes of element in which Point P lies are extracted and displacements interpolated at Point P to obtain the global Cartesian displacement.

$${[ \begin{matrix}{U}_{PX} & {U}_{PY} & {U}_{PZ}\end{matrix} ]}_{1 X 3} = {{[ \begin{matrix}N 1 & N 2 & N 3 & N 4 & N 5 & N 6\end{matrix} ]}_{1 x 6} [ \begin{matrix}{U}_{1 x} & {U}_{1 Y} & {U}_{1 Z} \\ ⋮ & ⋮ & ⋮ \\ {U}_{6 X} & {U}_{6 Y} & {U}_{6 Z}\end{matrix} ]}_{6 X 3}$$

Displacement Transformation

The flow is a function of the displacement of the bore and valve in the valve planes. Thus, some configurations of the present invention transform interpolated global displacement into a local Cartesian coordinate system. The local Cartesian coordinate system is rotated in anticlockwise direction with reference to the global coordinate system by the valve rotation angle.

$${[ \begin{matrix}{U}_{LX} \\ {U}_{LY} \\ {U}_{LZ}\end{matrix} ]}_{3 X 1} = {{[ T ]}_{3 X 3} [ \begin{matrix}{U}_{GX} \\ {U}_{GY} \\ {U}_{GZ}\end{matrix} ]}_{3 X 1} \\ [ T ] = [ \begin{matrix}Cos θ & Cos 90 & Cos ( 90 + θ ) \\ Cos 90 & Cos 0 & Cos 90 \\ Cos ( 90 - θ ) & Cos 90 & Cos ( 360 - θ )\end{matrix} ]$$

Where [T] represents transformation matrix and θ is valve rotation angle in the anticlockwise direction with reference to the global origin.

Choice of an Element

Some configurations of the present invention virtually predict the performance of a thermoplastic throttle body under temperature cycling conditions, and the effect of the this performance on flow variation. Thermoplastic material properties vary with processing conditions. Therefore, in some configurations, MOLDFLOW software is used to simulate thermoplastic properties. This simulation is followed by a structural or thermo-mechanical simulation using ABAQUS software. Currently, MOLDFLOW processing software allows only for 3-dimensional linear tetrahedron elements only. The same grid is required by ABAQUS software. However ABAQUS software release 6.1 is now available and allows the first order tetrahedron mesh used in MOLDFLOW software to be upgraded to second order tetrahedrons in ABAQUS software. Although a higher order “brick” would be the most accurate element for capturing deformation, a second order tetrahedron is used in some configurations due to the importance of processing information.

FE model details

In some configurations, the interpolation procedure requires that certain features in the FE model be generated before the scripts can be used, for example, the second order tetrahedral mesh for the bore and valve models is generated first. The model is oriented such that the Z-direction represents the bore axis and the global origin corresponds to the bore-center. In some configurations, the FE models element and node number are constrained to be in the compressed form. If additional ribs or design features are added, renumbering should be performed following this addition. A nodal component representing the bore-inner surface and valve outer surface is created in some configurations of the present invention. This nodal component represents a shared boundary between the structural and fluid domain. In some configurations, local Cartesian coordinate systems representing planes that bound the region of interest are created in the FE model before the search algorithm code is used.

Results of the sequential structural and fluid analysis are presented. Thermal deformation analysis under the assumption of uniform expansion at 150 deg. Celsius was performed using ABAQUS software. Bore and valve deformation was obtained. Aluminum properties were used for the throttle bore and the plate. The developed search and interpolation procedure was used to capture deformation of the bore and the valve in a location of interest. For the sample case, a valve angle of 10.64 was considered.

Local displacements at the three planes were used to update the point cloud representing the zone of interest. The deformed points were used to generate a CAD model that captureed the deformed geometry of the bore and the valve. A CFD grid using the deformed CAD model was generated and a mass flow simulation was performed on the deformed model.

CFD model predictions for an undistorted case at room temperature were benchmarked using experimental data. Good correlation was observed between CFD mode predictions and experimental trials.

It will thus be appreciated that of the present invention can be used to generate numerical predictions for computing variation in material property, and/or the effect of this variation on clearance and consequently on mass flow variation with design parameters. Configurations of the present invention can thus be used to economically and optimally design and develop thermoplastic throttle bodies, among other things.

While the invention has been described in terms of various specific embodiments, those skilled in the art will recognize that the invention can be practiced with modification within the spirit and scope of the claims.

What is claimed is:

1. A method for using an electronic computer to model a deformable object, said method comprising:
generating a point cloud of (x,y) coordinates;
developing computer aided design (CAD) surfaces at a region of interest (ROI) using the point cloud as an input; and
calculating a displacement field using a finite element method and the CAD surfaces.

2. A method in accordance with claim 1 further comprising adding a displacement to the point cloud to capture a structural deformation.

3. A method in accordance with claim 1 used for determining at least one of material flows, bore-valve deformations, or mass flow variance resulting from thermo-mechanical deformations of an object.

4. A method in accordance with claim 1 wherein the point clouds are generated using analytical relationships derived from progressive bores.

5. A method in accordance with claim 1 further comprising determining differential changes in the ROI and storing the differential changes as surface data from which a computational fluid dynamics (CFD) grid is calculated.

6. A method in accordance with claim 1 used to determine deformations of a valve, said method further comprising utilizing one or more interpolations to determine an ROI in which displacement is to be determined, as a function of valve rotation angle.

7. A method in accordance with claim 1 further comprising utilizing different mesh types and densities to discretize data in a structual domain and a flow domain.

8. A medium or media having recorded thereon machine-readable instructions configured to instruct a computer to model a deformable object, for which said instructions are configured to:
generate a point cloud of (x,y) coordinates;
develop computer aided design (CAD) surfaces at a region of interest (ROI) using the point cloud as an input; and
calculate a displacement field using a finite element method and the CAD surfaces.

9. A medium or media in accordance with claim 8 wherein said instructions further configured to instruct the computer to add a displacement to the point cloud to capture a structural deformation.

10. A medium or media in accordance with claim 8 further having recorded thereon instructions for determining at least one of material flows, bore-valve deformations, or mass flow variance resulting from thermo-mechanical deformations of an object.

11. A medium or media in accordance with claim 8 wherein the instructions to generate point clouds include instructions to generate the point clouds using analytical relationships derived from progressive bores.

12. A medium or media in accordance with claim 8 further having recorded thereon instructions for determining differential changes in the ROI and storing the differential changes as surface data from which a computational fluid dynamics (CFD) grid is calculated.

13. A medium or media in accordance with claim 8 further having recorded thereon instructions for utilizing one or more interpolations to determine an ROI in which displacement is to be determined, as a function of a valve rotation angle.

14. A medium or media in accordance with claim 8 further having instructions recorded thereon for utilizing different mesh types and densities to discretize data in a structual domain and a flow domain.

15. A computer system having at least one processor, a display, and memory comprising either primary memory or secondary memory, or both, wherein said memory includes instructions configured to:
generate a point cloud of (x,y) coordinates;
develop computer aided design (CAD) surfaces at a region of interest (ROI) using the point cloud as an input; and
calculate a displacement field using a finite element method and the CAD surfaces.

16. A computer system in accordance with claim 15 wherein said instructions further configured to instruct the computer to add a displacement to the point cloud to capture a structural deformation.

17. A computer system in accordance with claim 15 wherein said instructions further configured to determine at least one of material flows, bore-valve deformations, or mass flow variance resulting from thermo-mechanical deformations of an object.

18. A computer system in accordance with claim 15 wherein the instructions configured to generate point clouds include instructions configured to generate the point clouds using analytical relationships derived from progressive bores.

19. A computer system in accordance with claim 15 wherein said instructions further configured to determine differential changes in the ROI and storie the differential changes as surface data from which a computational fluid dynamics (CFD) grid is calculated.

20. A computer system in accordance with claim 15 wherein said instructions further include instructions configured to utilize different mesh types and densities to discretize data in a structual domain and a flow domain.
